(19) United States
(12) Patent Application Publication
(10) Pub. No.: US 2002/0050664 A1
(43) Pub. Date: May 2, 2002

(54) Gate flow diverter, mold for use therewith, and method for use thereof

(76) Inventors: Roy E. Moore JR., Killingworth, CT (US); Daniel J. Swistak, Newmarket, NH (US)

Correspondence Address: CANTOR COLBURN, LLP, 55 GRIFFIN ROAD SOUTH, BLOOMFIELD, CT, 06002

(21) Appl. No.: 09/981,299

(22) Filed: Oct. 17, 2001

Related U.S. Application Data
(60) Provisional application No. 60/241,632, filed on Oct. 19, 2000.

(51) Int. Cl. B29C 45/00

(52) U.S. Cl. 264/328.12; 425/566; 425/577

(57) ABSTRACT

A method for molding comprises: passing molding material through a nozzle, a nozzle inlet, and a sprue; diverting the flow of the molding material into a mold cavity with a spreader; and introducing the molding material to the mold cavity. The spreader can be part of the mold or of the nozzle. In one embodiment, the mold can comprise: a mold cavity; a sprue in fluid communication with the mold cavity, the sprue having a nozzle inlet and being adapted to receive fluid from an injection nozzle; and a spreader protruding from an interior surface of the mold cavity opposite the sprue. Alternatively, the nozzle can comprise: a bore disposed within the nozzle; an orifice disposed at an exit end of the nozzle, wherein the orifice is in fluid communication with the bore; and a spreader movably disposed through at least a portion of the bore, wherein at least a portion of the spreader is adapted to extend from the bore to a point external to the nozzle such that when fluid exits the orifice in a fluid flow direction, the spreader will alter at least a portion of the fluid flow direction.

### CROSS REFERENCE TO RELATED APPLICATION

This application claims the benefit of the filing date of U.S. Provisional Application Ser. No. 60/241,632 filed Oct. 19, 2000, which is hereby incorporated by reference in its entirety.

### TECHNICAL FIELD

This disclosure relates to molding and, more particularly, to flow control of a molding material into a mold.

### BACKGROUND OF THE INVENTION

Injection molding, structural foam molding, and, more particularly, gas assisted injection molding processes have received great attention. In a conventional injection molding process, articles are manufactured by injecting a molten plastic or resin material into a mold cavity, and letting the material cool to form a molded article. Once the article is sufficiently cooled the mold cavity is opened and the article is released. It has been recognized that there were many restrictions in the conventional injection molding process, particularly in injecting molten resin into the mold cavity.

Conventional injection molding processes produce certain defects such as stress and warpage of the molded plastic part, formation of sink marks and rough surfaces on the appearance side of the injection molded part. Often times these problems arise when the molten plastic or resin is initially injected into the mold cavity. The molten plastic or resin strikes the opposing interior surface of the mold cavity causing turbulence and back pressure at the entry point of the injection nozzle. When this happens, the injected resin does not flow smoothly through the mold, thus causing defects in the molded products, such as bubbles that contain air pockets, as well as depressions, warpages, and/or other imperfections. At the same time the molten plastic or resin creates a backpressure at the nozzle, which requires increased injection pressure to fill the mold. Conventional methods currently require using molding materials having higher melting points, or employing an injection molding machine having a greater clamp tonnage. Given the likelihood that turbulence and back pressure occurs more often with conventional methods and apparatus, the molten plastic or resin will likely collect within the nozzle and obstruct the flow due to the back pressure.

Consequently, there exists a need to enhance the flow of molding material into the mold cavity and to prevent the formation of obstructions within the mold.

### SUMMARY OF THE INVENTION

Disclosed herein are a mold, nozzle, and method for use thereof. The mold comprises: a mold cavity; a sprue in fluid communication with the mold cavity, the sprue having a nozzle inlet and being adapted to receive fluid from an injection nozzle; and a spreader protruding from an interior surface of the mold cavity opposite the sprue, wherein the spreader protrudes into the mold cavity and into the sprue.

The nozzle comprises: a bore disposed within the nozzle; an orifice disposed at an exit end of the nozzle, wherein the orifice is in fluid communication with the bore; and a spreader movably disposed through at least a portion of the bore, wherein at least a portion of the spreader is adapted to extend from the bore to a point external to the nozzle such that when fluid exits the orifice, the spreader will alter at least a portion of the fluid flow direction.

Meanwhile, the method for molding comprises: passing molding material through a nozzle, a nozzle inlet, and a sprue in fluid communication with a mold cavity; and diverting the flow of the molding material into the mold cavity with a spreader, wherein at least a portion of the spreader is disposed within the sprue.

The foregoing and other features will become more apparent from the following description of the best mode and accompanying drawings.

### BRIEF DESCRIPTION OF THE DRAWINGS

Referring now to the drawings, wherein like elements are numbered alike in the several figures:

FIG. 1 is a cross-sectional view of an exemplary embodiment of a nozzle seat, sprue, and spreader configuration;

FIG. 2 is a cross-sectional view of another exemplary embodiment of the sprue and spreader configuration shown in FIG. 1;

FIGS. 3-8 are exemplary embodiments of spreader designs;

FIG. 9 is a cross-sectional view of an exemplary embodiment of a sprue and spreader configuration utilizing the spreader shown in FIG. 6;

FIG. 10 is an exemplary embodiment of the appearance side of a molded part made using the spreader;

FIG. 11 is a cross-sectional view of another exemplary embodiment of a nozzle seat, sprue, and spreader configuration;

FIG. 12 is an enlarged cross-sectional view of the sprue and spreader configuration shown in FIG. 11; and

FIG. 13 is a cross-sectional view of yet another exemplary embodiment of a nozzle seat, sprue, and spreader configuration.

### DESCRIPTION OF THE BEST MODE

A sprue flow diverter and enhancer can comprise one or more nozzle seats disposed along the surface of a mold in fluid communication with one or more sprue(s). The sprue, which is in fluid communication with a mold cavity, comprises a nozzle inlet at one end designed to engage a nozzle. A spreader, preferably concentrically centered below the nozzle inlet during use, can be employed to divert the flow of molding material entering the sprue from the nozzle. The spreader can either protrude from the opposing interior surface of the mold cavity or can slidably disposed in the nozzle such that during use it is extended in to the sprue to divert the mold material flow direction, thereby reducing back pressure and turbulence. Essentially, in either design, molding material passes through the nozzle, out of a nozzle orifice, and through the nozzle inlet of the sprue. Within the sprue at least a portion of the molding material engages the spreader that redirects the molding material flow direction into the molding cavity. By preventing the molding material from engaging the interior wall of the mold cavity (e.g., hitting the cavity wall at a large angle (e.g., about 90°)), possible turbulence and back pressure typically associated with injecting molding processes, is reduced.

“Molding material” is understood to mean any plastic material composition that exhibits plastic flow properties under injection molding temperature and pressure conditions. “Molding material” includes all organic and inorganic materials having, with or without additives, thermoplastic characteristics, including certain synthetic organic resins (such as polyethylene and polyvinyl chloride, and the like) that also possess thermoplastic characteristics; and other resins, such as phenolic resins, and the like, having thermosetting characteristics. More specifically, the molding material can comprise thermoplastic and thermoset materials, or combinations comprising at least one of these materials, such as polyolefins, polypropylenes, polyethylenes (both high and low density), and the like, as well as composites, combinations, polymers, and copolymers comprising at least one of the foregoing materials. Some possible high density polyethylenes include “ALATHON” and “PETROTHENE”, commercially available from Equistar Chemicals, Houston, Tex. “SCLAIR” and “NOVAPOL”, commercially available from Nova Chemicals, Pittsburgh, Pa.; “MARTEX” and “PCR”, commercially available from Phillips Chemical, Bartlesville, Okla.; and “FORTIFLEX”, commercially available from Solvay Polyers, Houston, Tex. and the like.

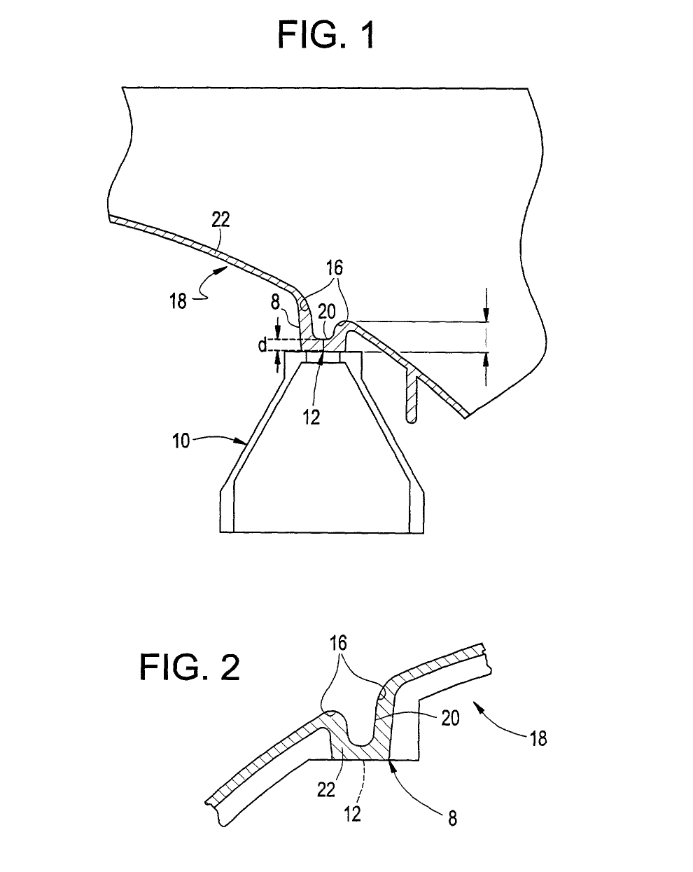

FIG. 1 depicts an exemplary embodiment of a sprue flow diverter and enhancer. A nozzle 10 (otherwise known as a nozzle seat), which is disposed in physical contact with a surface 18 of the mold, is in fluid communication with a sprue 8. The sprue 8 comprises a nozzle inlet 12 disposed on the sprue 8 such that nozzle inlet 12 is opposite a spreader 20.

Nozzle inlet 12 can be defined by any geometry capable of receiving an injection nozzle. Possible geometries can include round, oval, oblong, circular, or polygonal (e.g. hexagonal, septagonal, and the like), and the like. Preferably the geometry enables an injection nozzle 10 to connect and sealingly secure to the nozzle inlet 12 to prevent molding material from seeping out of the mold between the nozzle 10 and the nozzle inlet 12. The diameter of the nozzle inlet 12 is based upon the size of the part to be molded and, therefore the corresponding, desired mass flow rate through the nozzle inlet 12. The diameter can increase as the resulting molded part's weight increases, and, correspondingly, can decrease as the part's weight decreases, thereby accommodating different flow rates for varying quantities of injected molding material. This diameter can be up to about 3 inches or greater, with a diameter of less than or equal to about 1 preferred, less than or equal to about 0.750 inches more preferred, and a diameter of less than or equal to about 0.625 inches especially preferred.

Large injection molded parts could not be easily molded due to the inherent obstacles of using large quantities of pressurized molding material at temperatures up to about 600° C. or greater, that must cool and set quickly. Since the nozzle inlet 12 can have a diameter of up to about 3 inches, or greater, manufacturing a larger molded part can be accomplished quickly. Therefore, the production of larger articles is enabled due to the smooth flow of molding material enabled by the combination of the larger nozzle inlet 12, the spreader 20. Reduced cooling times, resulting from the reduced mass of material disposed near the sprue (i.e., dislodged by the spreader), also contributes to the ability to utilize larger molded parts in reduced time.

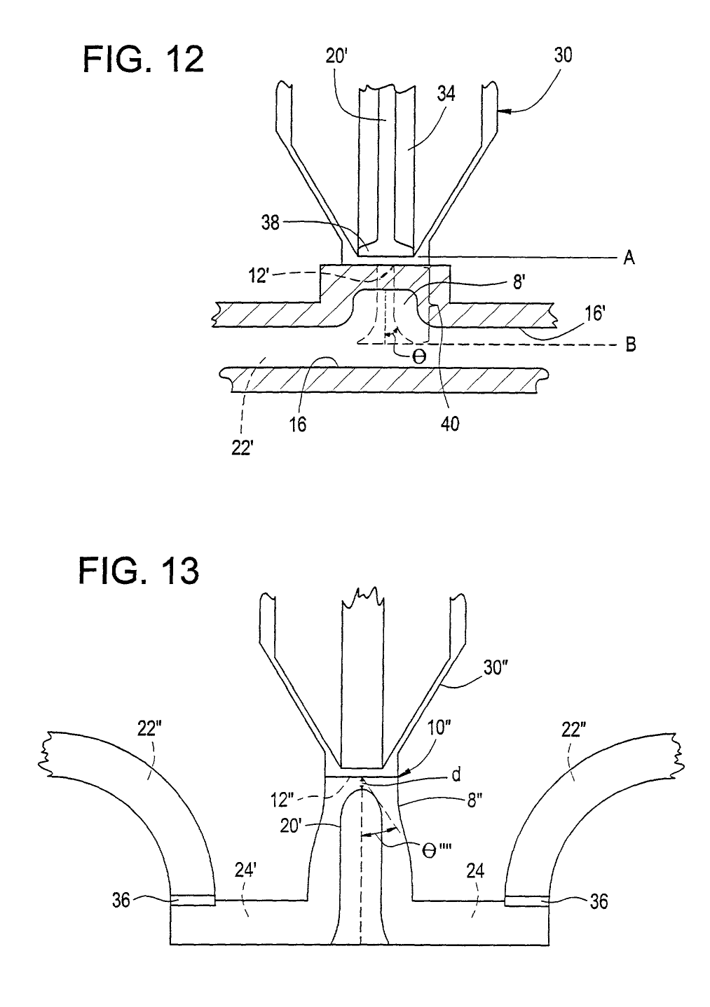

The spreader 20, which is at least partially disposed in the material flow stream during use, is preferably concentrically centered in the nozzle inlet 12. Typically the spreader is either a protrusion projecting outward from an interior surface 16 of the mold cavity 22 (spreader 20) or is a part of the nozzle assembly (spreader 20′). (See FIGS. 1 and 12) The spreader 20,20′ can have any geometry that can alter the flow direction of the mold material and that can preferably cause the injected molding material to flow substantially unrestricted within the mold cavity 22. Possible geometries can include cylindrical (e.g., with a rounded, pointed, flattened end, and the like), rounded, pyramidal, pointed, conical (e.g., a truncated cone having a rounded convex surface), teardrop, and the like. In order to reduce/prevent turbulence and back pressure, it is further preferred that the sides of the spreader 20 angle or flare outward (i.e., diverge from a centerline of the spreader), in the direction of the flow. The angle θ, θ′, θ″ of the outward flare is chosen based upon the geometries of the mold cavity 22 and spreader 20, and can be different for each side of the spreader 20 (See FIGS. 3-8). Although the angle(s) can be less than or equal to about 89°, angles greater than about 70° are typically not employed, with angles of less than or equal to about 60° generally preferred, angles less than or equal to about 35° more preferred, and angles less than or equal to about 20° especially preferred.

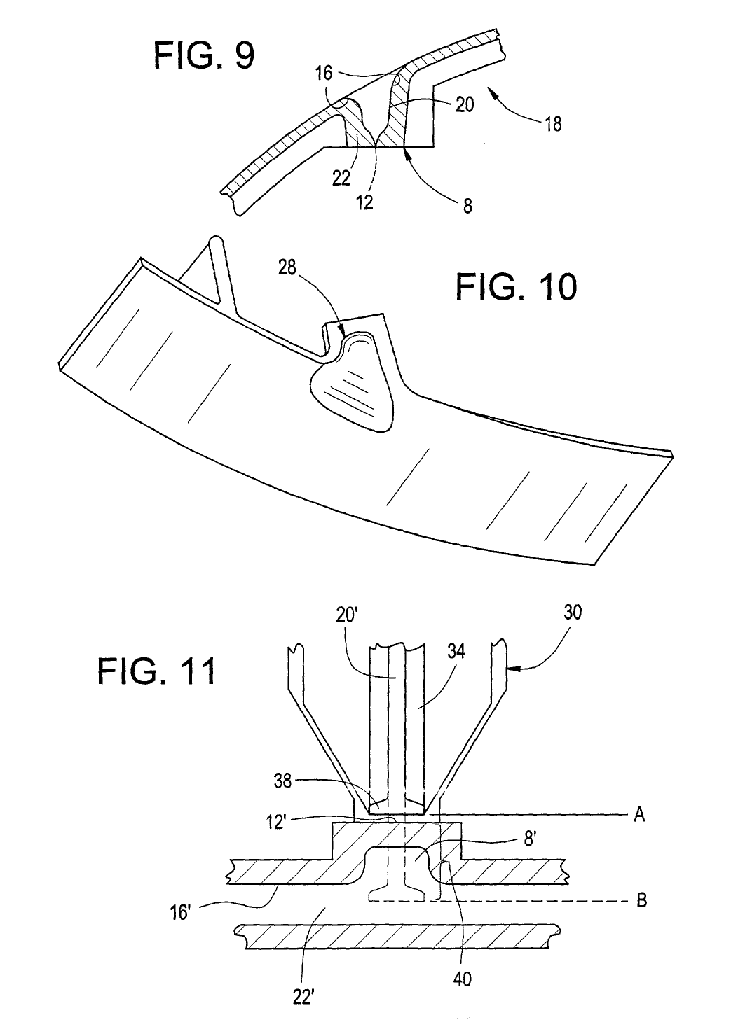

The dimensions of the spreader 20, i.e., the diameter and length, are similarly based upon obtaining the desired flow characteristics. The diameter is chosen based upon the spreader's location with respect to the nozzle inlet 12 (See FIG. 1). Generally, the spreader 20 is disposed in the proximity of nozzle inlet 12, such that the molding material flow through nozzle inlet 12 is not inhibited, while turbulence and back pressure are reduced or eliminated. As shown in FIG. 1, a sufficient distance “d” can exist between the nozzle inlet 12 and spreader 20 so that the molding material flow can be optimally re-directed to reduce turbulence and back pressure. Alternatively, the spreader 20 can project outwardly until the end of the spreader 20 adjacent nozzle inlet 12 extends to nozzle inlet 12 (See FIG. 9). In that situation, nozzle inlet 12 can have a diameter greater than the diameter of the spreader 20 to accommodate the diminished distance between spreader 20 and nozzle inlet 12, e.g. the distance depicted in FIG. 1.

Fractures and microcracks could possibly occur in spreader 20 due to the pressure exerted by an excess amount of molding material within an annular gap that is too small. By sizing the dimensions of the spreader 20 according to the diameter of the nozzle inlet 12, the sprue 8, and the quantity of injected molding material, the spreader 20 evenly diverts the molding material into mold cavity 22. Without the spreader 20, the injected molding material can rebound against the opposing interior surface 16 of mold cavity 22, and create back pressure within the mold cavity 22. The back pressure forces the molding material back into sprue 8, which obstructs the nozzle inlet 12 and increases the injection pressure. The interaction between the spreader 20 and nozzle inlet 12 can eliminate turbulent opposing flows of injected molding material that can obstruct the nozzle inlet 12.

The specifications, the length and other dimensions of the sprue 8, nozzle inlet 12 and spreader 20 can vary according to the application, e.g. the size of the mold cavity 22, and/or the quantity of injected molding material. The nozzle diameter is preferably substantially equivalent to the nozzle inlet diameter to inhibit leaking (if the nozzle diameter is smaller than the inlet diameter), and back pressure and turbulence if the nozzle diameter is larger than the nozzle inlet diameter (e.g., to prevent molding material from striking and rebounding off the exterior surface of the mold). Similarly, the spreader 20 whose size is based upon attaining the desired flow characteristics, can have a diameter up to the size of the nozzle inlet diameter, with a diameter of less than or equal to about 70% of the nozzle inlet diameter preferred, and a diameter of less than or equal to about 50% of the nozzle inlet diameter especially preferred. Also preferred is a spreader diameter of greater than or equal to about 10% of the nozzle inlet diameter, with a diameter of greater than or equal to about 20% of the nozzle inlet diameter especially preferred. Similar to the diameter, the length, “1”, of the spreader 20 is based upon attaining the desired flow characteristics. Typically, the length is up to about 100% of the sprue length, with a length of less than or equal to about 85% of the sprue length preferred, and a length of less than or equal to about 70% of the sprue length especially preferred. Also preferred is a length of greater than or equal to about 20% of the sprue length, with a length of greater than or equal to about 40% of the sprue length especially preferred.

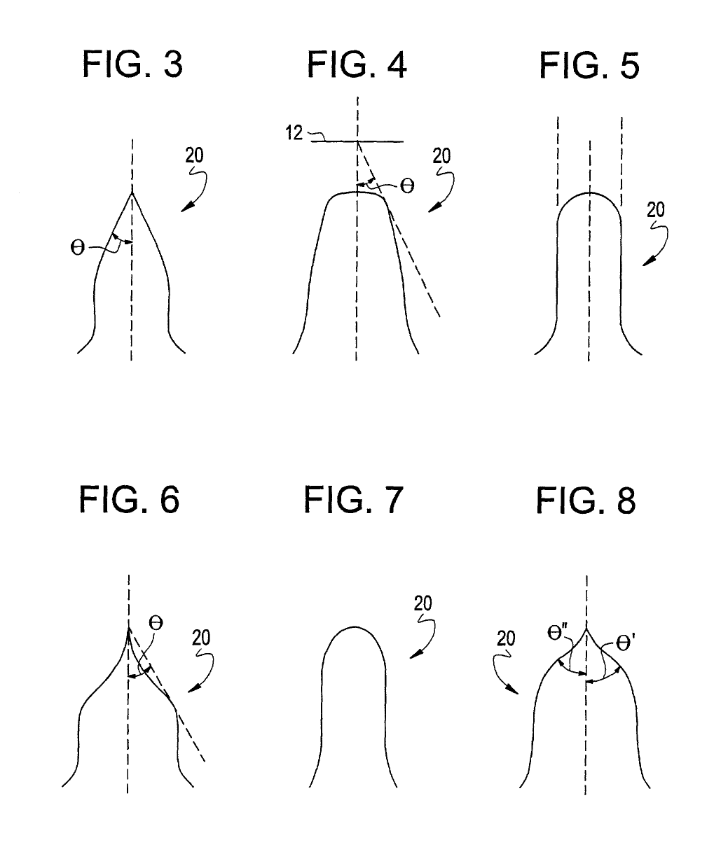

Also, in order to reduce/prevent turbulence and back pressure, it is further preferred that the sides of the spreader angle or flare outward as embodied by both spreader 20 and 20′. (Note, as is shown in FIG. 4, the angle θ is typically measured from the nozzle inlet 12 to a point tangential with the side of the spreader.) The angle θ′, θ″, θ′″ of the outward flare is chosen based upon the geometries of the mold cavity 22,22′,22″ and spreader 20,20′, and can be different for each side of the spreader 20,20′. The angle θ′, θ″, θ′″ of the outward flare is preferably consistent with the outward flares of angles θ, θ′, θ″, θ′″ for spreaders 20 and 20′, respectively. Although the angle(s) can be less than 90°, angles greater than about 70° are typically not employed, with angles of less than or equal to about 60° generally preferred, angles less than or equal to about 35° more preferred, and angles of less than or equal to about 30° especially preferred. Further preferred is an angle of greater than or equal to about 15°.

During operation, heated molding material passes through the nozzle 10, the nozzle inlet 12, and contacts the spreader 20 that directs the molding material into the mold cavity 22. Once the molding material fills the mold cavity 22, the molding material can begin to cool. As the molding material cools and sets in place, a raised area 28 may form on the appearance side of the molded part where the spreader 20 is located (See FIG. 10). Although the raised area 28 comprises a dense area of molding material, when compared to the density of the entire surface area of the molded part, the raised area 28 cools and sets in place quickly due to using the apparatus and method disclosed herein. Furthermore, this area of molding material cools more quickly than that in a system that doesn't employ the present sprue/spreader design due to the increased flow rate of the molding material as a result of the larger nozzle inlet diameter, and sprue/spreader configuration described herein.

FIGS. 11-12 illustrate alternative embodiments where an injection nozzle assembly 30 can be equipped with a retractable spreader 20′. The injection nozzle assembly 30 can comprise a bore 34 having a spreader 20′ disposed therein in a first position A, wherein the spreader 20′ is retracted within the bore 34. When the injection nozzle 30 is fitted to the nozzle seat and in fluid communication with the sprue 8′ through nozzle inlet 12′, a first end 38 of the spreader 20′ can extend into the sprue 8′ to a second position B. Position B indicates any position at a sufficient distance 40 that the spreader 20′ can divert and redirect the molding material flow to reduce turbulence and back pressure. Since this position is based upon the nozzle inlet geometry and spreader geometry, the position B can be anywhere from the curved portion of the spreader being disposed at the nozzle inlet to the first end 38 of the spreader being in physical contact with the mold wall. Generally, the spreader 20′ is extended to position B within the sprue 8 in the proximity of the interior surface 16′ of mold cavity 22′, such that the molding material flow through nozzle inlet 12′ is not inhibited, and turbulence and back pressure are reduced or eliminated. Furthermore, the spreader 20′ can have a diameter adjacent the nozzle that is less than or equal to about 70% of the orifice diameter.

As the molding material enters the mold cavity 22′ through the bore 34 of injection nozzle 30, rather than striking a stationary spreader, such as spreader 20, the molding material flow can be diverted by the angled surface of the slidable spreader 20′. At any point during the molding process, and preferably once the mold material fills mold cavity 22, the spreader 20′ can optionally be retracted to position A. When the spreader 20′ is retracted, it will not produce the above-described depressions on the appearance side of the molded part.

FIG. 13 illustrates yet another exemplary embodiment of the method and apparatus disclosed herein. A sprue 8″ can be positioned outside or away from the mold cavity 22″, such that the injected molding material flows through the sprue 8″, runner 24, and edge gates 36, to enter the mold cavities 22″. The injection nozzle 30″ is fitted to the nozzle seat 10″, which is in fluid communication with the sprue 8″through nozzle inlet 12″. The spreader 20′ is positioned within the base of the sprue 8″, and in fluid communication with nozzle inlet 12″. As the molding material enters the sprue 8″, the material strikes the spreader's angled surface, diverting the flow through runners 24, 24′ and into the edge gates 36. The molding material flows in a uniform manner through the edge gate 36 and into the mold cavity 22″. In this embodiment, the mold cavity 22″ can be detached from the edge gate 36 without creating a depression, dimple or hole in contrast to the other exemplary spreader and sprue configurations described herein.

The method and molding apparatus provides several advantages over existing injection molding machines, molds, and methods that do not employ this sprue/spreader configuration. The combination of components allows for improving the flow of molding material into a mold cavity. The combination described herein can also increase injection speeds thus facilitating faster injection and, ultimately, an overall faster cycle time in producing molded parts. Furthermore, fewer nozzles are required to fill the mold cavity since the molding material flows more quickly with the spreader and sprue configuration described herein than with non-sprue/spreader nozzles and since larger nozzles and nozzle inlets are employable with this configuration. In addition, by eliminating a turbulent opposing flow from a single nozzle or several nozzles, the mold cavity pressure is also reduced. Consequently, the sprue and spreader configuration can be employed in both low pressure molding processes (i.e., about 0 psi up to about 5,000 psi) and high pressure molding processes (i.e., up to about 20,000 psi or more). Manufacturing molded articles on a larger scale can now be accomplished without the inherent obstacles encountered when using pressurized molding material in large-scale injection molding processes.

The combination of the nozzle inlet and spreader also enhances the flow of molding material into the mold cavity in several advantageous ways. Typically, when using non-sprue/spreader injection molding methods, the molding material enters the mold cavity and strikes the interior surface of the mold cavity. As the flow rate and/or velocity of the molding material is increased, the molding material flow becomes more turbulent and causes back pressure to form. Eventually, the back pressure forces the molding material back into the injection nozzle and obstructs it. However, in the instant application, the spreader prevents the flow from becoming turbulent by diverting the molding material. The molding material is re-directed along the angularly flared exterior surface of the spreader. The motion causes the molding material to flow more evenly while reducing the turbulence. Decreasing the turbulence of the flow correspondingly decreases the formation of back pressure. As a result, the likelihood of obstructions and fluid material buildup within the injection nozzle is significantly reduced by placing the spreader below the injection inlet.

In addition, when employing non-sprue/spreader molding techniques, warpages and other physical and structural defects are more likely to occur when the resin creates an obstruction upon entering the mold cavity. However, in the instant application, the constant motion caused by the redirected molding material can orient and uniformly layer the polymer molecules of the molding material within the mold cavity, thus improving the part's physical characteristics and properties. Additionally, the resulting molded part can have a lighter weight due to the uniform layering of the polymeric molecular chain structure within the mold cavity.

Yet another advantage is that, non-sprue/spreader injection molding methods cannot cool molding material as quickly as the sprue/spreader configuration and, as a result, the diameter of the nozzle must be restricted. Basically, the employment of the spreader reduces the quantity of mold material disposed in the proximity of the sprue. Less material enables a faster cooling time and reduced problems associated with cooling and warpage. In turn, due to the reduced amount of material, a larger nozzle inlet diameter can be utilized which facilitates an increased flow of molding material and the ability to mold larger articles. In contrast, large molded parts cannot be easily manufactured using a non-sprue/spreader injection molding process due to the inherent obstacles using an enormous amount of pressurized molding material at a temperature of about 400° F. to about 600° F. or more, that must cool and set quickly. Since the molding material can be injected more quickly using the exemplary combinations disclosed herein without the likelihood of forming an obstruction, the nozzle inlet diameter can be significantly increased. The exemplary combinations provide improved cooling capabilities that can facilitate the use of larger nozzle diameters to introduce larger quantities of molding material at faster injection rates. This, in turn, facilitates manufacturing much larger molded parts.

Lastly, molding material introduced into a mold cavity at a faster filling rate more evenly distributes itself within the mold cavity. The even distribution of molding material within the mold cavity creates a part that weighs less due to more even weight distribution and decreased packing pressure. A lightweight molded part naturally requires less cooling time, which also facilitates an overall faster cycle time.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A mold, comprising:
a mold cavity;
a sprue in fluid communication with the mold cavity, the sprue having a nozzle inlet and being adapted to receive fluid from an injection nozzle; and
a spreader protruding from an interior surface of the mold cavity opposite the sprue, wherein the spreader protrudes into the mold cavity and into the sprue.

2. The mold recited in claim 1, wherein at least a portion of the spreader is concentrically disposed within the sprue.

3. The mold recited in claim 1, wherein the spreader extends from the interior surface to the nozzle inlet.

4. The mold recited in claim 1, wherein the spreader has a geometry selected from the group consisting of rounded, pyramidal, pointed, conical, and teardrop.

5. The mold recited in claim 4, wherein the spreader has a geometry is a truncated cone having a rounded surface.

6. The mold recited in claim 1, wherein a first angle θ exists between an intersection of a centerline of the spreader at the nozzle inlet and a first side of the spreader, and wherein the first angle θ is less than 90°.

7. The mold recited in claim 6, wherein the first angle θ is less than or equal to about 60°.

8. The mold recited in claim 7, wherein the first angle θ is less than or equal to about 35°.

9. The mold recited in claim 8, wherein the first angle θ is about 15° to about 30°.

10. The mold recited in claim 6, wherein the spreader has a second side, the second side having a second angle θ different from the first angle θ.

11. The mold recited in claim 1, wherein a diameter of the sprue is sufficiently larger than a diameter of the spreader.

12. The mold recited in claim 1, wherein the spreader diameter is equivalent to or less than a nozzle inlet diameter.

13. The mold recited in claim 12, wherein the spreader diameter is about 10% to about 70% of the nozzle inlet diameter.

14. The mold recited in claim 13, wherein the spreader diameter is about 20% to about 50% of the nozzle inlet diameter.

15. The mold recited in claim 1, wherein the spreader has a geometry selected from the group consisting of rounded, pyramidal, pointed, conical, and teardrop.

16. The mold recited in claim 15, wherein the spreader has a geometry is a truncated cone having a rounded surface.

17. A method for molding, comprising:
passing molding material through a nozzle, a nozzle inlet, and a sprue in fluid communication with a mold cavity; and
diverting the flow of the molding material into the mold cavity with a spreader, wherein at least a portion of the spreader is disposed within the sprue.

18. The method recited in claim 17, further comprising injecting at least a portion of the molding material at a pressure of up to about 20,000 psi.

19. The method recited in claim 18, further comprising injecting at least a portion of the molding material at a pressure of greater than 0 psi up to about 5,000 psi.

20. The method recited in claim 17, further comprising diverting the molding material through an edge gate into the mold cavity.

21. A nozzle, comprising:
a bore disposed within the nozzle;
an orifice disposed at an exit end of the nozzle, wherein the orifice is in fluid communication with the bore; and
a spreader movably disposed through at least a portion of the bore, wherein at least a portion of the spreader is adapted to extend from the bore to a point external to the nozzle such that when fluid exits the orifice in a fluid flow direction, the spreader will alter at least a portion of the fluid flow direction.

22. The nozzle recited in claim 21, wherein at least a portion of the spreader extending outside of the orifice has diverging sides.

23. The nozzle recited in claim 22, wherein the sides diverge at an angle θ of less than 90° from a centerline of the bore.

24. The nozzle recited in claim 21, wherein the angle θ is less than or equal to about 35°.

25. The nozzle recited in claim 24, wherein the angle θ is about 15° to about 30°.

26. The nozzle recited in claim 21, wherein the spreader has a diameter adjacent the nozzle that is less than or equal to about 70% of an orifice diameter.
